(19) United States
(12) Patent Application Publication
(10) Pub. No.: US 2007/0104496 A1
(43) Pub. Date: May 10, 2007

(54) Illuminated output presence indicator

(75) Inventors: Mark S. Penke, West Henrietta, NY (US); Debora Margaret Hejza Littwiller, Rochester, NY (US)

Correspondence Address: JAMES J. RALABATE, 5792 MAIN STREET, WILLIAMSVILLE, NY, 14221, US

(73) Assignee: Xerox Corporation

(21) Appl. No.: 11/272,128

(22) Filed: Nov. 10, 2005

(51) Int. Cl. G03G 15/00

(52) U.S. Cl. 399/16

(57) ABSTRACT

In a production, fax or printing system, collection stations are sometimes obscure to the user. This invention provides a sensor connected to a light source that illuminates this collection station when a product or copy is present so that the presence of the product or copies to be collected is apparent to a user.

### FIELD

This invention relates, generally, to collection stations in machines and systems and, more specifically, to marking systems with collection stations.

### BACKGROUND

Many collection stations in systems having product transportation from production to a collection point are obscure and sometimes difficult to find. This is true, for example, in marking or printing systems such as in image-forming machines where a marked medium is moved to a collection station. Electrophotography is such a system. Electrophotographic image-forming machines are used to transfer images onto paper or other medium in both printing and facsimile systems. Generally, a photoconductor is selectively charged and optically exposed to form an electrostatic latent image on the surface. Toner is deposited onto the charged photoconductor surface. The toner has a charge, thus it will adhere to the photoconductor surface in areas corresponding to the electrostatic latent image. The toner image is transferred to the paper or other medium. The paper is heated for the toner to fuse to the paper. The photoconductor is then refreshed—cleaned to remove any residual toner and charge—to make it ready for another image. The imaged paper is then passed to a document output collection area or tray where the user collects the finished, permanently imaged paper or documents.

In some of today's newer, complex, multifunctional printers, copiers or fax machines, there is some difficulty in seeing the document output tray because of its obscure location. On these machines, the primary output tray is somewhat hidden as it is generally located directly below the scanner and control panel. Many newer copiers and multifunction devices also utilize a compact architecture which does not leave room for easily observed output trays. The primary output area for copies, prints and faxes is contained within the footprint of the (Image Output Terminal) IOT. This creates a smaller footprint than more traditional approaches which utilize an output tray mounted to the side of the IOT.

A disadvantage is that, because of this obscured output tray, customers often experience difficulty in seeing those printed documents. Control panels located above and in front of the output area often obstruct visibility. Additionally, cast shadows in the recessed output area further disguise the presence of the printed documents. Machines with fax functionality have-a compounded problem with obscured output collection stations. This is because in fax machines, users often do not know when a document is being received. This problem exists in electrophotographic and non-electrophotographic machines.

As a result, customers tend to search for their documents or simply are unaware these documents have been delivered to the output area. This leads to both frustration and a loss of productivity.

Some current solutions use a message sent on the user interface (UI) which alerts the user that a job has been completed. The disadvantages in this approach are that the message is spatially disconnected from the actual output area and that the user must take the time to read the message.

Therefore, operators or users have frequent difficulty finding the semi-obscured output area, holding the documents, reducing their ability to find some or all of the finished product.

Also, it is difficult for people with handicaps, such as people sight- or hearing-impaired, to locate the output station containing the documents.

The above is also true in other product delivery systems, especially small products such as nails, screws, pens, pencils, erasers, keys, etc. where the products are moved to an obscured collection station where they are hard to find or the operator is unaware product has been delivered.

### SUMMARY

While it is obvious to use or adapt the defined embodiments herein, in any product producing system where a product is transferred or moved to a collection point, electrophotographic systems will be used as examples to clearly illustrate said embodiments herein.

In this embodiment, a light source is located in proximity to the output tray area (collection station) and will illuminate documents in the output tray or collection station. This light would illuminate only when documents are present in the collection station. The light could be color coded to indicate status and various information relating to the copies in the tray. The lamp would light only when a sensor is activated and at least one finished document is present in the tray.

There are a variety of ways in which the document output illumination feature can be implemented. They include but are not limited to the following ways.

At least one light source can be mounted either directly above or below the output area on a vertical or horizontal surface located adjacent to the area or in other locations. This illuminated effect can be created through the use of various light bulbs including fluorescent and incandescent, electro-luminiscent sources or Light Emitting Diodes (LEDs). Additionally, as above noted, colors can be utilized for additional effect and visual impact through the use of filters or through the use of colored LEDs.

In practical application, the LEDs in one embodiment may provide a convenient solution due to low costs, low energy consumption, long operating life, small size, comparative brightness and low heat generation.

The on/off sequence can also be implemented in a number of ways including but not limited to the following:

When a copy, print or fax job in one embodiment is initiated the light source is automatically turned on in response to a signal from a sensor. It can stay on until a specified period of time after the completion of the job has passed.

When a copy, print or fax job is initiated in an embodiment, the first sheet out activates either an optical, mechanical or other sensor starting the illumination process. When the operator has removed the copies or sheet(s), the sensor is activated once again, sending a message to shut off the illumination source.

When a copy, print, multi-function marking system or fax job is initiated in an embodiment, the first sheet out passes a sensor located at either or both the exit point of the paper path or at the collection station, the illumination process is started. When the last sheet passes the sensor, a signal is sent to maintain the illumination for a set specified period of time.

A variety of sensors can be used successfully in triggering the light activation when paper is deposited in the exit tray. Some examples of sensors that can be used are electromechanical sensors, which would be physically activated by the paper itself, which would then send a signal to the light source for energization. Another type of sensor could be optical, which would have a sender and receiver, which when the paper interrupts the optical beam, would send a signal for the light source to be energized. Another could be a mechanical sensor that utilizes a spring device to make the electrical contact. Obviously any suitable sensor or sensors may be used.

Additionally, various combinations of items in the above paragraphs can be utilized.

Through the use of a sensor in operative relationship to the output area, the illumination and other signals may stay on indefinitely until the documents have been removed. This would alert others who may be passing by the machine that a job has been completed.

Should a job be left in the output area for an extended period of time, the lights may flash on and off to conserve energy and to provide an additional way to gather a customer's attention. To be effective, the illumination and other signals must be apparent for easy recognition in normal, artificially and naturally lit work environments. The light or other signals can also be timed to the energy saver mode and turned on or off depending on the energy or sleep mode constraints.

The energization of the exit lights can be utilized for variety of conditions valuable to the user. One is capacity of the tray; color coding of the exit lights could communicate the fill capacity of the exit tray. For example, no paper present, all exit lights off. A small amount of paper present, and a single light or a color light (such as a green light) could be energized. As the tray fills with more paper, an orange light could energize (and the green light would de-energize), or a second light could be energized making the illuminated surface appear more brilliant. Upon max fill levels, a red light could energize (the orange light turns off) indicating max capacity has been reached. Or a third light could energize or Another way to communicate max capacity is to blink the light until the paper is removed.

Another use of colored lights could be for identification of the type of job in the tray. For example, a blue light would be illuminated if the paper was an incoming fax job. Or a orange light could be used for print jobs. Lights could also be tied to a persons identification utilizing the device's software a user would have on their PC. For example, using the devices software, a user could tag “Jim's print jobs” to a blue light, and “Sally's print jobs” to a yellow light and so on and so on. When Jim sends a print job, he can easily see from a distance that his job is ready by the blue illuminating light. If Sally sends a job, her light would be illuminated. The user could have the last job sent light be on or select having the lights turn on in sequence to indicate multiple jobs received.

Yet, another use of the exit lights would be to indicate condition. A single color would indicate paper in the tray. A secondary color (such as red) could indicate there is an error condition that needs operator attention.

As earlier noted, any apparatus adapted to produce a product may be used where the apparatus comprises in operative relationship the product producing station and a product conveyance system. The product is moved through the system toward a collection area or station. Along the way, the product triggers or energizes a sensor or sensors whereby the sensor turns on an illumination source adapted to light up the collection station. The sensor can also activate other alerting signals such as audio or vibrating signals. This activation can occur during and/or after conveyance of the product to the collection station.

### BRIEF DESCRIPTION OF THE DRAWINGS

FIG. 1 illustrates in one embodiment a machine having a marked paper collection station where the collection station is illuminated from above.

FIG. 2 illustrates in one embodiment a product or paper output tray having a marked paper product collection station that is illuminated from below.

FIG. 3 illustrates in one embodiment a product or paper output tray having an illumination signal, an audio signal and a vibration signal.

FIG. 4 illustrates a typical prior art fax or copier machine having an obscured output tray or product collection area.

FIG. 5 illustrates an embodiment where a sensor located along the travel path of a product or copy is in an inactive position.

FIG. 6 illustrates in the embodiment of FIG. 5 this same sensor along the travel path of a product or copy where the sensor activates illumination of the output station.

### DETAILED DISCUSSION OF DRAWINGS AND PREFERRED EMBODIMENTS

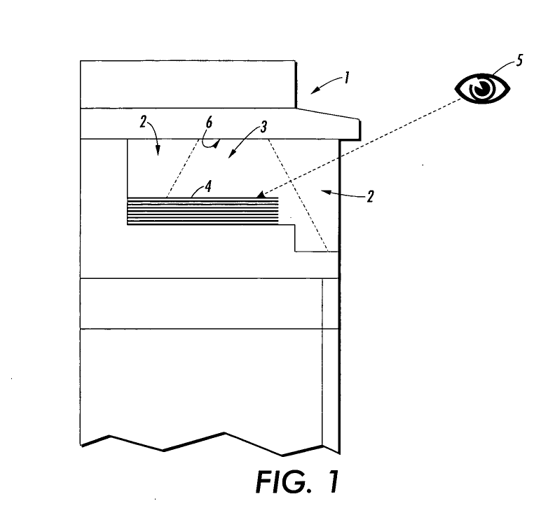

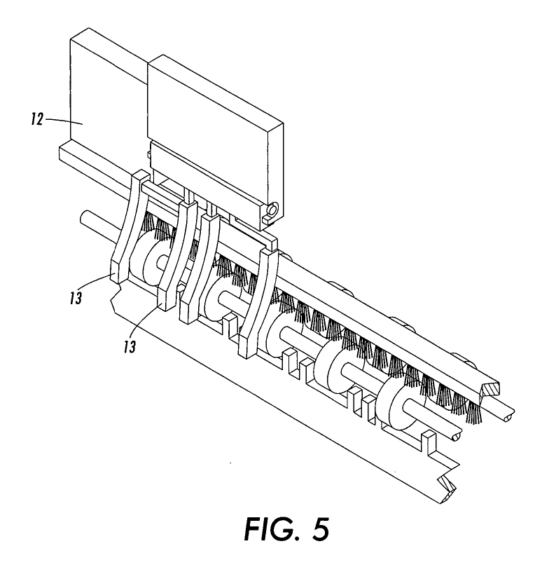

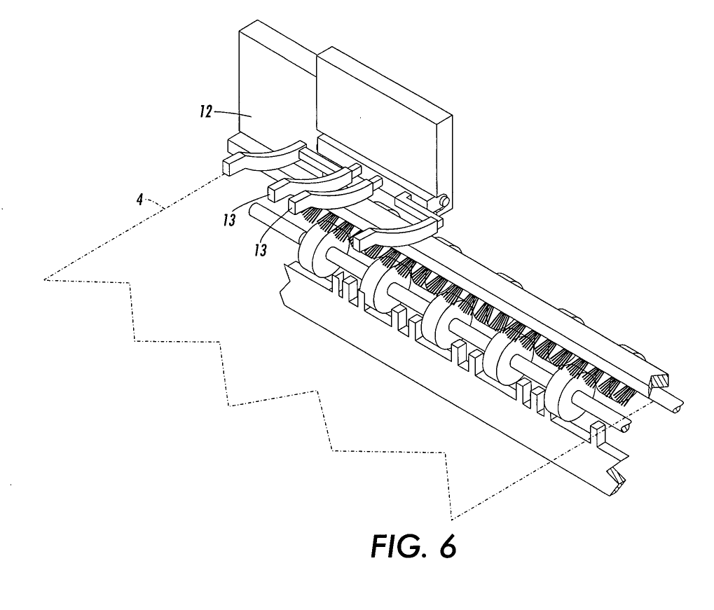

In FIG. 1, a side view of a fax, printer or reproduction machine 1 is illustrated, depicting a output tray or collection area or station 2 that is not clearly and easily observed. The collection area 2 in this embodiment is illuminated from above by a light source 3 which substantially improves visual observation for user 5 of the output 4 located in the collection station 2. The apparatus or machine 1 is adapted to produce finished output or receiving members 4 transported from a marking station to collection station 2. The apparatus 1 comprises at least one sensor 12 in the interior of machine 1 (an embodiment shown in FIGS. 5 and 6). This sensor 12 is operatively connected to a light source 3 which as shown will illuminate the collection station 2 containing the marked paper copy or receiving members 4.

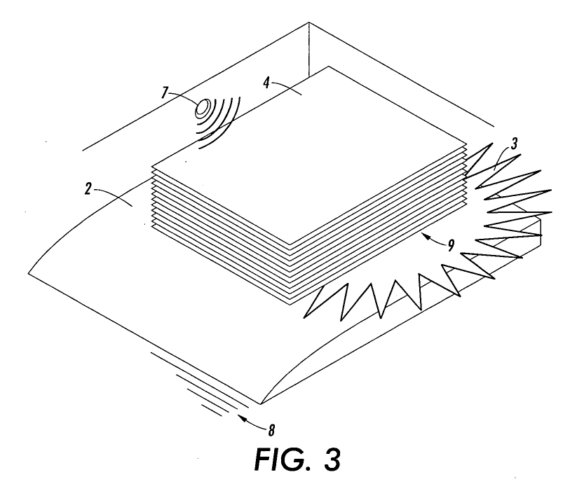

The machine 1 can be either electrophotographic or not, or can be an electrophotographic printer, copier, duplicator, facsimile, communication system or multi-function machine or other machine that delivers a product to a collection area. By multi-function system is meant an apparatus that can function as a copier, a printer, a computer network, a facsimile, or a communication device. The word “printer” as used herein encompasses any apparatus such as a digital copier, bookmaking machine, facsimile machine, multi-function machine, etc. which performs a print outputting function for any purpose. Although a monochrome printing apparatus has been described herein, the claims can encompass embodiments that print in color or handle color image data. While the location of the sensor 12 or sensors can be anywhere in the machine, a specific location can be in the paper path (as shown in FIGS. 5 and 6). Suffice it to say that the important sensor 12 feature is that it can activate lighting source 3 in addition to other signals later described. In this embodiment light source 3 is mounted at location 6 above the copies 4. The light source 3 can be at least one fluorescent light(s), incandescent light(s), electro-luminescent light(s), light emitting diodes (LEDs) and any combination of these. The location of light source 3 can be any suitable location in or in proximity to the collection station 2. Also the sensor 12 can be an electrical sensor, a mechanical sensor, an optical sensor, other suitable sensors or any mixtures of these. It is important that the sensor 12 be capable of both activating only a light source 3 to illuminate the collection station 2, or to activate light source 3 together with other suitable signals such as audio signal 7 and vibrating signal 8 as shown in FIG. 3.

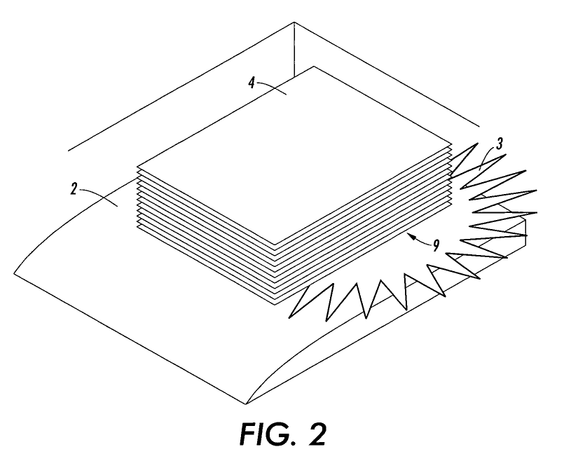

In FIG. 2, the light source 3 is provided below or in the lower portion 9 of the collection station of a marking or production system. The product from a production system or documents 4 from a printer will become more apparent to the user if collection station 2 is illuminated. “Product” as used herein includes any product from a production system that is moved to a collection station where a sensor indicates its presence.

In FIG. 3 a light source 3 is illustrated for use together with audio signal 7 and vibrating signal 8. The product or the marked receiving members or paper 4 collect in collection station 2 at the completion of or during a job. The sensor(s) 12 activate light source 3 together with either or both audio signal 7 and vibrating signal 8, or any other suitable signal. These signals are activated during and after a job in the machine 1 is completed, or for a predetermined time. The machine 1 in one embodiment is a multi-function reproduction machine.

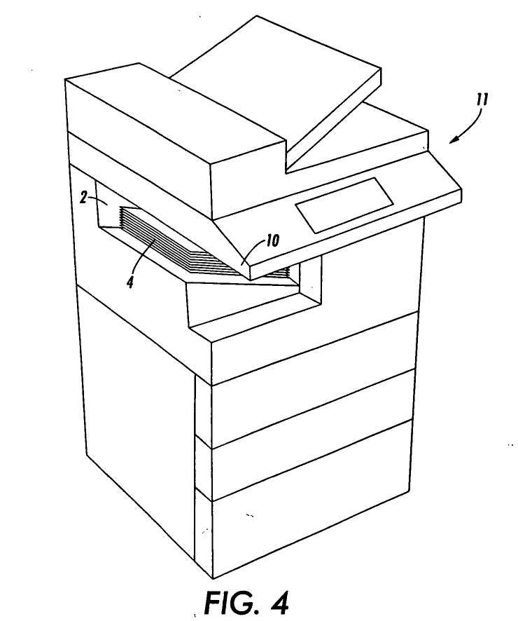

In FIG. 4, a typical prior art machine 11 with prior art non-illuminated collection station 2 is shown. Note that the collection station 2 is not readily observable because usually it is indented and under overhanging panel 10. Documents 4 are easily and commonly left in collection station 2 because of its obscure location. Also, handicapped people can have a particularly difficult time locating finished documents 4.

In FIG. 5, a portion of the product or paper path of a document is shown where sensor 12 is in a rest or inactive position. The sensor 12 comprises movable arms 13 that will be moved and rise into an active position once a product, paper or receiving member 4 makes contact therewith and pushes arms 13 upwardly to an activation position.

In FIG. 6, arms 13 of the sensor 12 are pushed upward when a product or sheet of paper 4 passes therethrough forcing movable arms 13 upward in an activating position. At this activating position, the sensor 4 now activates or turns on light source(s) 3 to illuminate the collection station 2. As earlier noted, once activated, the sensor 4 can also turn on or activate audio alarm or signal 7 and vibrating 8 signals. As noted earlier, other suitable sensors and signals may be used.

While this invention has been described by embodiments relating to facsimile machines and electrophotographic copiers, printers and duplicators, obviously other machines that produce products or copies can utilize the present invention. Therefore, the present invention includes any apparatus adapted to produce a product or finished documents of at least one marked receiving member. This apparatus comprises in operative relationship at least one product producing station or marking station and a conveyance system which is enabled to move said product or receiving member from said product producing or marking station to a collection station. This apparatus comprises at least one sensor enabled to indicate the presence of at least one of said products or receiving members in said collection station. This sensor is operatively connected to at least one light source which is adapted to illuminate said collection station containing said receiving members during and after production of said products or marking of said marked receiving members is completed and said product or receiving members are deposited in said collection station. The light source is activated alone or together with other signals such as audio signals and vibrating signals.

The preferred and optimally preferred embodiments of the present invention have been described herein and shown in the accompanying drawings to illustrate the underlying principles of the invention, but it is to be understood that numerous modifications and ramifications may be made without departing from the spirit and scope of this invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A marking system and process which comprises in an operative arrangement at least one sensor, a marking station, a sheet(s) collection station with a signal, a sheet conveyance and path, and at least one sensor, said sensor enabled to activate at least one signal including illumination at said collection station, said sheet conveyance enabled to convey said paper along said path extending from said marking station and ending at a paper exit, said paper exit enabled to allow said sheets to pass therethrough into said collection station, located along said sheet conveyance path and before said collection station is at least one of said sensors, at least one of said sensors enabled along said conveyance path to activate said signal when a first sheet passes therethrough and enabled to inactivate said signal and shut off said signal at a predetermined or fixed period of time after said sensor is activated, said signal including a light that illuminates said collection station, said sensor located in said path of said sheet conveyance and before said collection station is enabled to activate a signal for said predetermined period of time when a first sheet enters said path, said signal including signals selected from the group consisting of light, color coded lights, audio signals, vibrating signals and mixtures thereof, said at least one sensor also enabled to shut off said signal in said collection station at a preset time after activation of a sensor.

29. The system of 28 wherein a sensor is located at least at both a beginning point on said path and a sheet end point of said path.

30. The system of 28 wherein said illumination is color coded to indicate various information relating to the sheets, including a number of said imaged documents in the collection station.

31. The system of 28 wherein said illumination will flash to provide an additional means to attract a user's attention.

32. The system of 28 wherein said sensors in said path are selected from the group consisting of electronic sensors, optical sensors, mechanical sensors, and mixtures thereof.

33. The system of 28 wherein said sheet or imaged document is moved through the system along said path, said path having at least one sensor before said collection station and wherein the sheet triggers or energizes at least one sensor that turns on an at least one sensor and turns off said signal after a preset time, including an illumination source at said collection station.

34. The system of 28 wherein said system comprises a machine selected from the group consisting of multi-function machines, printers, duplicators, and facsimile.
